(19) United States
(12) Patent Application Publication
(10) Pub. No.: US 2012/0247255 A1
(43) Pub. Date: Oct. 4, 2012

(54) MONO-RAIL SHIFTING DEVICE

(75) Inventors: Ulrich Fritschle, Tettnang (DE); Ulrich Stracke, Friedrichshafen (DE); Gerhard Horing, Hagnau (DE)

(73) Assignee: ZF FRIEDRICHSHAFEN AG, Friedrichshafen (DE)

(21) Appl. No.: 13/511,213

(22) PCT Filed: Nov. 3, 2010
(86) PCT No.: PCT/EP10/66674

§ 371 Date: May 22, 2012

(30) Foreign Application Priority Data
Dec. 9, 2009 (DE) 10 2009 047 715.2

(51) Int. Cl. F16H 59/04

(52) U.S. Cl. 74/473.25

(57) ABSTRACT

A monorail shifting device (1) for a multi-gear variable-speed transmission with a gearshift rail (2), a shifting element (3) and a selector element (5). The gearshift rail (2) is arranged and can be displaced axially, in a transmission housing (10), and the shifting element (3) is connected to the gearshift rail (2), fixed in the axial direction. The shifting element (3) transmits axial shifting movement selectively to one of a plurality of shifting fork arms (6, 7, 8). Relative to the transmission housing (10), the selector element (5) is fixed in the axial direction on the housing. The shifting element (3) and the selector element (5) can pivot together about a central axis (11). A shift position detent (18) acts between the shifting element (3) and the selector element (5). Furthermore, the monorail shifting device is typically incorporated into a multi-gear variable-speed transmission.

This application is a National Stage completion of PCT/EP2010/066674 filed Nov. 3, 2010, which claims priority from German patent application serial no. 10 2009 047 715.2 filed Dec. 9, 2009.

### FIELD OF THE INVENTION

The present invention concerns a monorail shifting device for a multi-gear variable-speed transmission.

### BACKGROUND OF THE INVENTION

It is known in automate shifting sequences in multi-gear variable-speed transmissions, that the shifting elements are moved not manually, but by actuators. For this, monorail shifting systems are also known, in which only one shift actuator for shifting the gears in combination with a selection actuator for selecting the desired shifting gate in each case is used. For example, DE 10 2005 001 551 A1 describes a monorail shifting device with only one shift actuator and one selection actuator. In that case the selection movement is kinematically decoupled from the shifting movement, so that the gearshift rail does not move during the selection movement for selecting the desired shifting gate. To shift the gears, the gearshift rail is pushed by the shift actuator in its axial direction. The shifting movement of the gearshift rail in the axial direction is transmitted by a shifting finger connected to the gearshift rail in an axially fixed position, respectively to a selected shifting fork arm and farther to an associated shifting rocker or shifting fork. The shifting rockers or shifting forks engage in shifting sleeves which, in turn, can move between a disengaged neutral position and at least one engaged position for shifting the gears. In the engaged position, the drive torque is transmitted by a gearset associated with the shifting sleeve concerned.

The kinematic decoupling of the selection movement from the shifting movement has the advantageous result that the force required for selecting the shifting gate is substantially reduced and so enables the use of an electromagnetic or electro-dynamic selection actuator with smaller dimensions and more rapid response behavior than, for example, a pneumatic actuator. In turn, smaller dimensions of the selection actuator enable a more flexible arrangement of the components on or in the transmission. Suitable designs for an electromagnetic or electro-dynamic selection actuator are described for example in DE 10 2005 001 551 A1 and these can also be used in connection with the present invention.

For an accurate approach to and reliable maintenance of the neutral position and/or the engaged position by the shift actuator, detents are also known which act upon the axially displaceable gearshift rail. Such a detent is known, for example, from DE 10 2005 022 995 A1.

### SUMMARY OF THE INVENTION

The purpose of the present invention is to provide a monorail shifting device for the selection and shifting of various gears in a multi-gear variable-speed transmission, with a detent system for the shifting movement, which takes up as little fitting space as possible and can be assembled as simply as possible, as well as to indicate a variable-speed transmission with a monorail shifting device of such type.

This objective is achieved by a monorail shifting device and by a transmission according to developments of the invention.

Accordingly, a monorail shifting device for a multi-gear variable-speed transmission with a gearshift rail, a shifting element and a selector element is claimed, in which the gearshift rail is arranged in an axially displaceable manner relative to a transmission housing. The shifting element is connected fixed to the gearshift rail in the axial direction, and transmits the axial shifting movement of the gearshift rail selectively to one of a plurality of shifting fork arms. The selector element is fixed in the axial direction in the transmission housing and is connected to the shifting element in a rotationally fixed manner. The shifting element and the selector element are mounted on the gearshift rail in such manner that the two of them together can pivot about a common central axis, whereby the selection movement for selecting the desired shifting gate is carried out.

According to the invention a shift position detent is provided, which is arranged effectively between the shifting element and the selector element, by means of which the monorail shifting device can be detained in at least a neutral position and/or a shift position.

The arrangement of such a shift position detent between the shifting element and the selector element enables an even more compact structure of the entire shifting device, since the shift position detent can be accommodated spatially within the fitting space required in any case by the shifting element and the selector element. Furthermore, this enables a unit comprising the shifting element, the selector element and the shift position detent to be pre-assembled and their co-operation to be tested before the assembly of the transmission as a whole. Optionally, the unit can also be pre-assembled with a gearshift rail.

A first preferred embodiment of the invention provides that at least one prestressed springy detent element is arranged on the shifting element and can engage in retaining recesses provided in the selector element. In this case the shifting element is preferably in the form of a shifting ring arranged on the gearshift rail concentrically with a common central axis thereof. This design enables a compact structure of the shifting device, particularly in the axial direction.

A particularly preferred design of the above-described embodiment provides that the detent element comprises a spiral compression spring at each end of which a detent sleeve is arranged. The spiral compression spring with the detent sleeves is arranged in a through-bore in the shifting ring so that the detent sleeves are pushed in opposite directions out of the two ends of the through-bore into corresponding retaining recesses in the selector element. In this case the retaining force acts in the tangential direction relative to the shifting ring. The retaining forces on the two detent sleeves are of equal size but act in opposite directions, to that they cancel out and no resultant force, which could influence the shifting or selection process, is produced.

In contrast to the first embodiment described above, another preferred embodiment of the invention provides that the prestressed detent element is arranged on the selector element and can engage in at least one retaining recess provided in the shifting element. In this case the selector element preferably has a sleeve-shaped main body and is arranged concentrically relative to the sleeve-shaped or annular shifting element. In this way the shifting element and the selector element can be arranged for example as two sleeves with different diameters concentric with one another and one inside the other, which further reduces the fitting space required.

The detent element arranged on the selection sleeve preferably comprises a compression spring whose force acting on the detent can be adjusted by means of a locking screw.

In both of the embodiments described above the shifting element has a shifting finger solidly attached thereto, which when selecting the shifting gate is brought selectively into force-transmitting connection with one of the shifting fork arms, for example by pivoting the shifting finger into a correspondingly shaped carrier groove in the particular shifting fork arm selected.

Preferably, the embodiments described have in the selector element a slot extending in the axial direction, through which the shifting finger of the shifting element extends. The free end of the shifting finger can project through the slot in the selector element, into a carrier groove of the shifting fork or shifting rocker selected, in order to engage a gear by moving in the axial direction to the desired shifting position.

In a further preferred design of the invention, the selector element has a locking element solidly attached thereto, such that whichever shifting fork arms have not been selected can be locked in a shifting position. For this purpose, for example close to the slot in the selector element a locking element is arranged in such manner that in every selection position of the selector element the locking element projects into the carrier grooves of the shifting fork arms not selected. This blocks the freedom of movement of the shifting fork arms in the axial direction, so ensuring that in any selection position only one shifting fork is actuated. Such a locking element, for example made integrally with the selector element, by virtue of the smaller number of components involved, reduces the assembly effort, costs, and the fitting space required compared with shifting devices with separately arranged locking elements.

Finally, a multi-gear variable-speed transmission is claimed, which comprises a monorail shifting device according to the invention.

### BRIEF DESCRIPTION OF THE DRAWINGS

The invention is explained in more detail below, with reference to two preferred example embodiments illustrated in the following figures.

The figures show:

FIG. 1: A first embodiment of the monorail shifting device according to the invention, viewed in perspective,

FIG. 2: The monorail shifting device of FIG. 1 viewed in section taken in the section plane along the central axis,

FIG. 3: The monorail shifting device of FIG. 1 viewed in section taken in a section plane perpendicular to the central axis,

FIG. 4: A second embodiment of the monorail shifting device according to the invention, viewed in section taken in a section plane along the central axis, and

FIG. 5: The second embodiment of the monorail shifting device according to the invention, viewed in section taken along the section line 5-5 shown in FIG. 4.

### DETAILED DESCRIPTION OF THE PREFERRED EMBODIMENTS

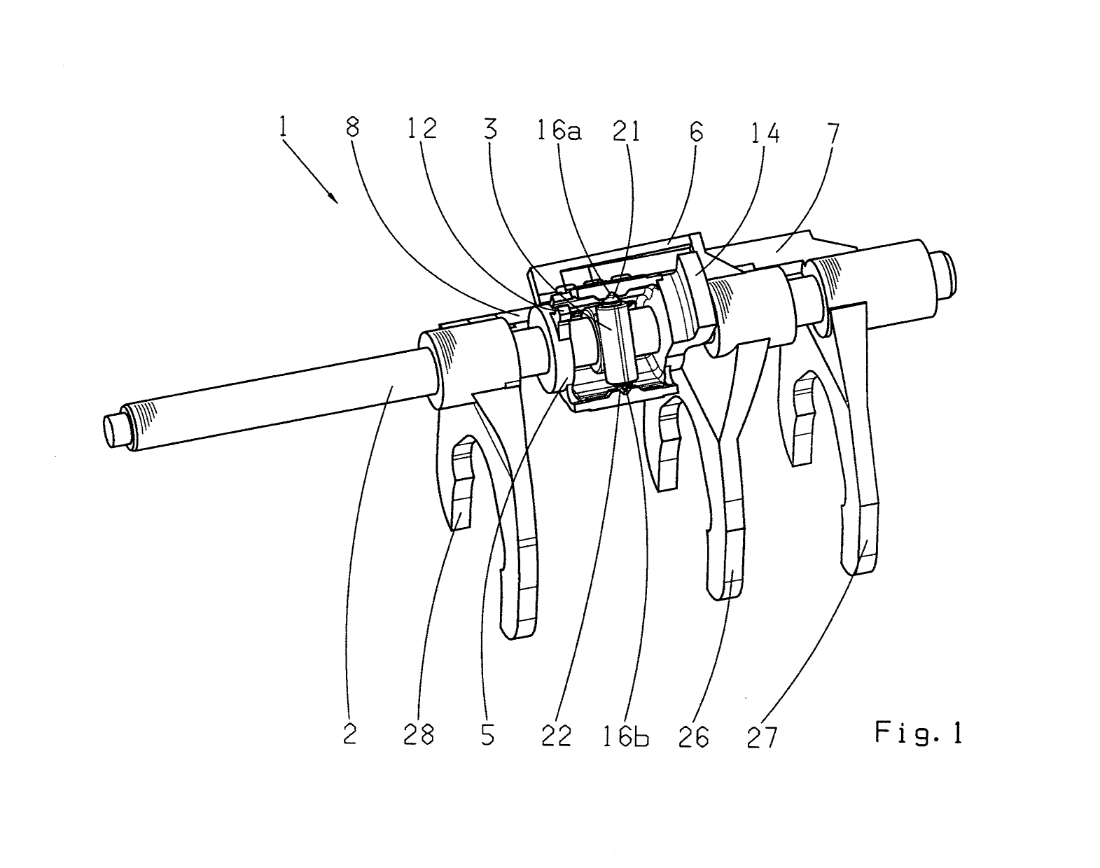

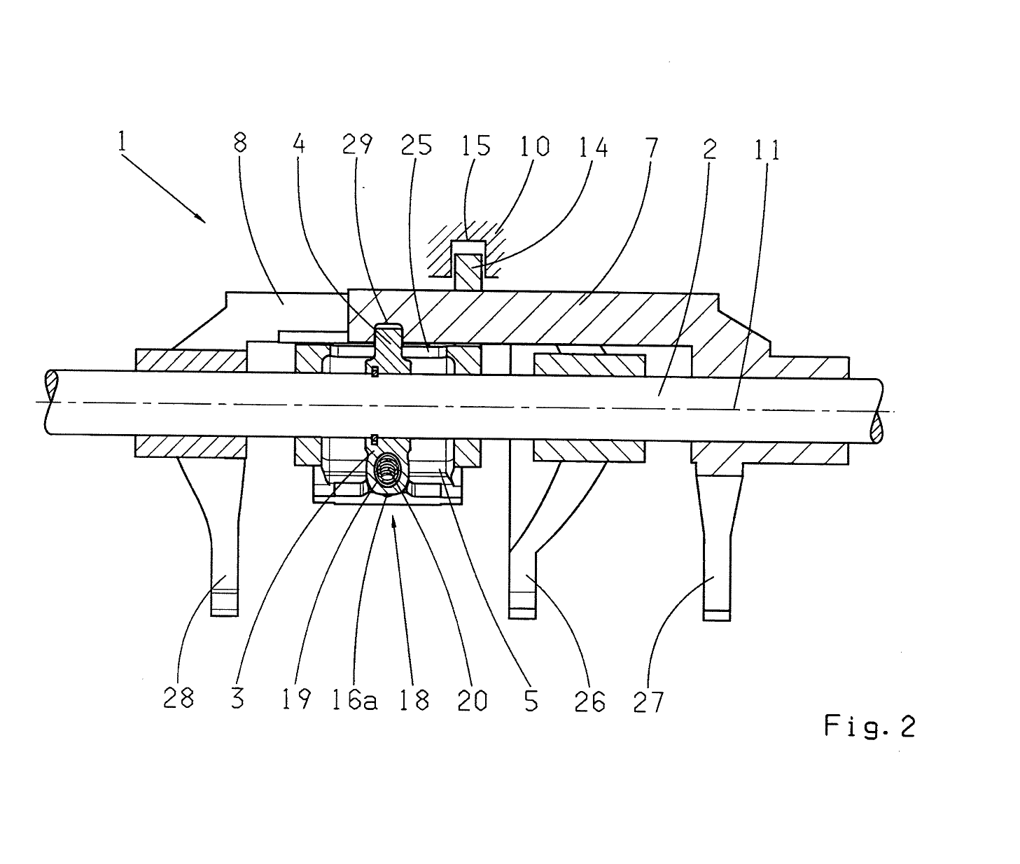

In the monorail shifting device 1 shown in FIGS. 1 to 3 the gearshift rail 2 is arranged centrally. The gearshift rail 2 is arranged inside a variable-speed transmission, mounted in a housing 10 and able to be displaced in the axial direction by a shift actuator (not shown) relative to the housing 10. The housing 10 can be the transmission housing itself or a separate housing within the transmission housing.

A shifting element 3 is arranged on the gearshift rail 2 and is connected to the gearshift rail 2 fixed in the axial direction. The shifting element 3 is designed as a shifting ring and is arranged on the gearshift rail 2 so that it can rotate freely about a central axis 11. Made integrally with the shifting element 3 is a shifting finger 4 that projects in the radial direction.

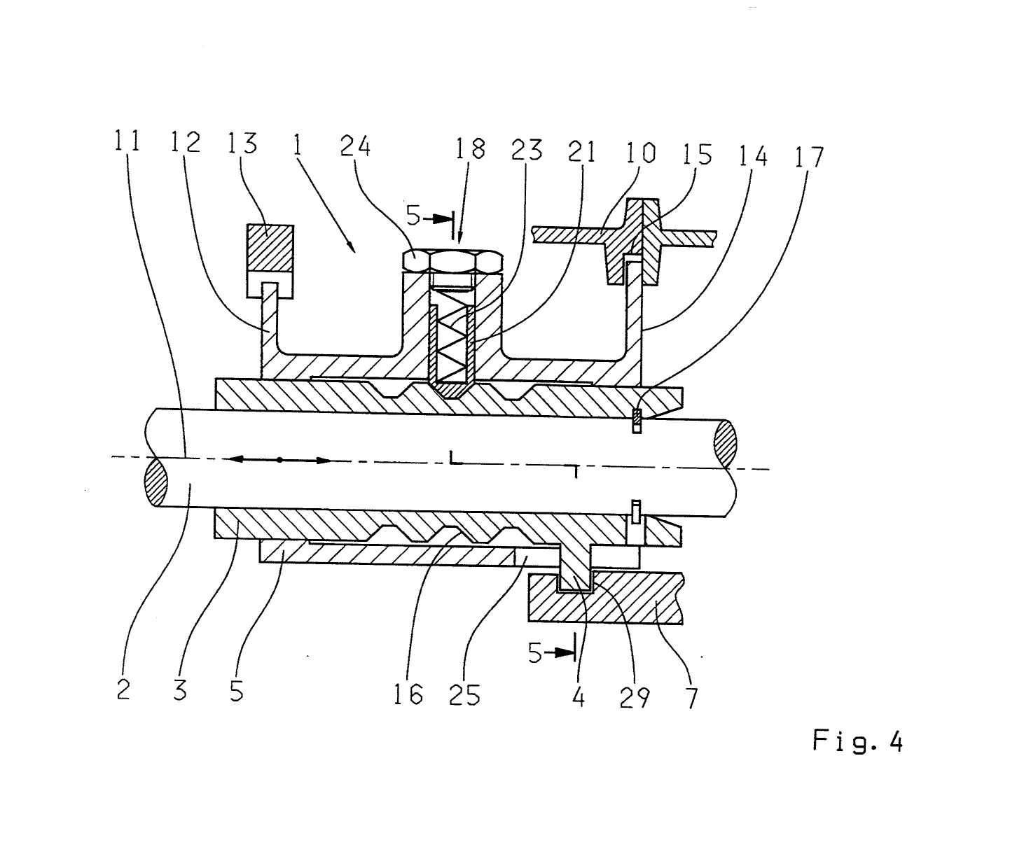

Axially displaceably on the gearshift rail 2 and also free to rotate relative to the gearshift rail 2 is arranged a selector element 5. The selector element 5 comprises a selection finger 12 with which a selection actuator 13 (shown in FIG. 4) is functionally connected, so that when the selector element 5 is rotated about the central axis 11 the desired shifting gate is selected. The transmission has at least two shifting gates. When the selector element 5 is rotated, the shifting element 3 rotates with it. This happens due to an interlocked connection between the shifting element 3 and the selector element 5, which is formed by the shifting finger 4 in combination with a slot 25 in the selector element 5. The shifting finger 4, made integrally with the shifting element 3, projects in the radial direction through the slot 25 into the selector element 5 and can move in the axial direction along the slot 25. The width of the shifting finger 4 is chosen such that on both sides it is in contact against the inner surfaces of the slot 25, so that in the rotational direction a virtually play-free, interlocked connection is formed and when the selector element 5 is rotated, the shifting element 3 is rotated with it through the same angle due to the shifting finger 4.

In this example three shifting forks 26, 27 and 28 are fitted on the gearshift rail 2 and able to move axially. Embodiments with a different number of shifting forks are also possible. Each of the shifting forks 26, 27 and 28 has a respective shifting fork arm 6, 7 and 8 connected solidly at one end to the associated shifting fork and having a carrier groove 29 in the area of the other end, into which the shifting element 3 projects with its shifting finger when the selection position is appropriate.

To fix the selector element axially and support retaining forces, the selector element 5 comprises an extension 14 made integrally with the selector element 5. In the assembled condition the extension 14 projects into a recess 15 in the transmission housing 10, so that in the axial direction the selector element 5 is fixed on the housing but can rotate about the central axis 11. For this purpose the recess 15 is shaped for example as a curved groove with a rectangular cross-section in the transmission housing 10, such that the groove extends in the rotational direction of the extension 14.

In another version (not shown) of the axial fixing of the selector element 5, the selector element 5 is guided axially by a pin. The pin is fixed into a bore in the housing and projects into a slot in the selector element 5. The slot extends perpendicularly to the rotational axis in the circumferential direction, in order to enable the selector element 5 to rotate about the central axis 11.

In this embodiment the shifting element 3 can be rotated easily thanks to a clearance fit and a circlip 17, but is mounted axially fixed on the gearshift rail 2. However, it can for example also be mounted by means of a roller bearing.

The shifting element 3 has a through-bore 19 in which is arranged part of the shift position detent 18. The shift position detent 18 comprises a spiral compression spring 20, the detent sleeves 21 and 22 and the retaining recesses 16a and 16b. In the through-bore 19 is located the spiral compression spring 20 at each end of which is arranged a respective detent sleeve 21 or 22 as a detent element. The outer diameter of the detent sleeves 21 and 22 is such that they are securely guided in the through-bore 19 but can be displaced easily, for example by the force of the spiral compression spring 20 itself. The selection movement is initiated by a selection actuator 13 which engages firmly on a selection finger 12 and thereby rotates the selector element together with the shifting element 3 about their common central axis 11.

In the assembled condition and in a central shift position, namely the neutral position shown in FIGS. 1 to 3, the detent sleeves 21 and 22 are pushed by the spiral compression spring 20 into the retaining recesses 16a and 16b in the selector element 5.

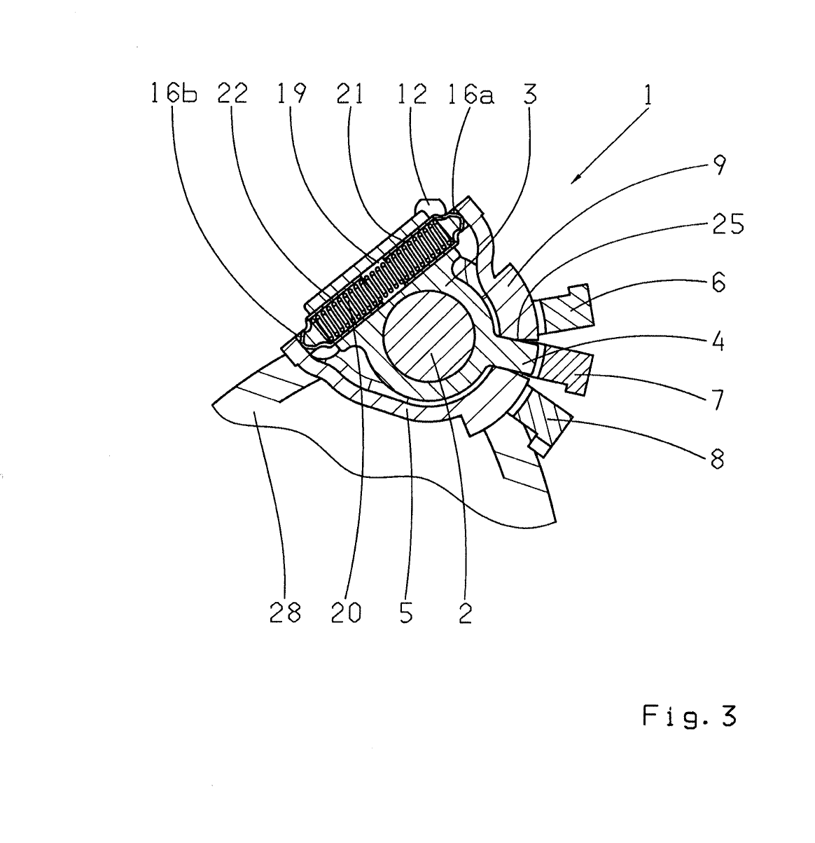

FIG. 3 shows a locking element 9 for locking the shifting fork arms 6, 7 or 8 that have not been selected. Close to the slot 25 through which the shifting finger 4 projects into the carrier groove 29 of whichever shifting fork arm 6, 7 or 8 has been selected, the locking element 9 is arranged fixed firmly on the selector element 5. In this example the locking element 9 is made integrally with the selector element 5.

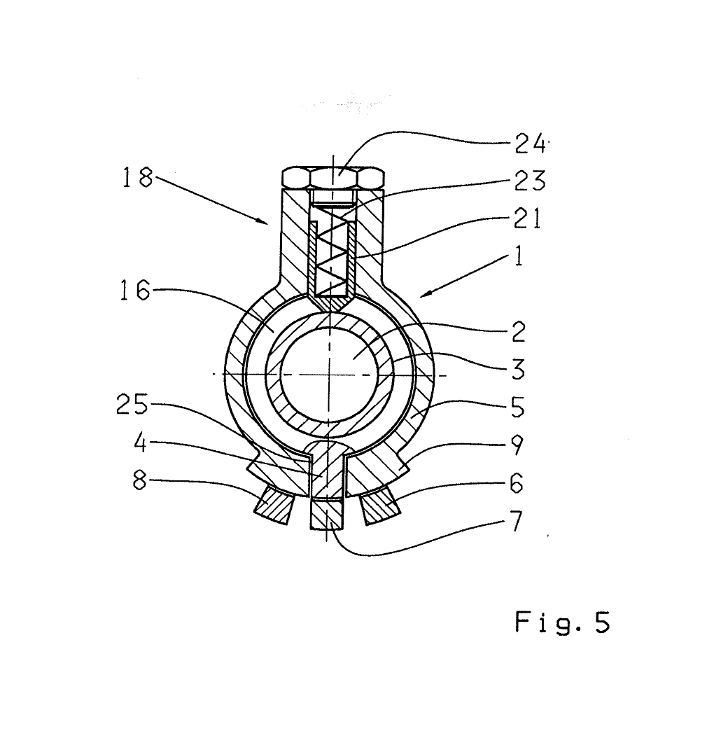

FIGS. 4 and 5 show a second embodiment of the invention. Components that perform the same function in the two embodiments are given the same indexes.

On the centrally arranged gearshift rail 2 the shifting element 3 in the form of a shifting sleeve is mounted and can rotate freely. In the axial direction the shifting element 3 is held fixed on the gearshift rail 2 by the circlip 17.

Concentrically to the sleeve-shaped shifting element 3, the also sleeve-shaped selector element 5 is fitted on the shifting element 3. In the axial direction the shifting element 3 can be displaced relative to the selector element 5. By means of its integrally formed extension 14 the selector element 5 is fixed in the transmission housing 10 in the axial direction. However, the selector element 5 can be rotated relative to the gearshift rail 2 about a common central axis 11.

The shifting element 3 has a shifting finger 4 fixed solidly on the shifting element 3, which projects through a slot 25 in the selector element 5 into a carrier groove 29 of whichever shifting fork arm 6, 7 or 8 has been selected. In combination with the slot 25 the shifting finger 4 again forms an interlocked connection for transmitting the selection movement from the selector element 5 to the shifting element 3, whereby the selector element 5 carries out any rotation movement for selecting a shifting gate together with the shifting element 3. In this case too the selection movement is initiated by a selection actuator 13 which engages with a selection finger 12 arranged solidly on the selector element 5 and thus rotates the selector element 5 together with the shifting element 3 about their common central axis 11.

As shown in FIG. 5, this embodiment as well comprises a locking element 9 fixed solidly on the selector element 5, which engages in the carrier grooves of the shifting fork arm 6, 7 or 8 that have not been selected and locks them fast relative to the housing, so that when the gearshift rail 2 undergoes an axial shifting movement, only the shifting fork 6, 7 or 8 that has been selected moves along with the gearshift rail 2.

In this second embodiment the shift position detent 18 is designed, in contrast to the shift position detent in the first example embodiment, such that a prestressed, springy detent element 21 is arranged on the selector element 5 and can engage in a retaining recess 16 arranged in the shifting element 3. The detent element 21 is pushed into the retaining recess 16 by a spiral compression spring 23, this spiral compression spring 23 being prestressed by a locking screw 24. Alternatively to the locking screw 24, the spiral compression spring can be held by a holding plate or a closing plug. In FIG. 4 the monorail shifting device 1 is detained in the central, neutral position. In addition, however, in the embodiment shown both of the shift positions can also be detained, as can be seen from the two retaining recesses arranged on either side of the retaining recess 16. To influence the size of the retaining force and its variation, the retaining recesses can also have various depths and shapes, such as rounded flanks.

In the two embodiments described, the function of the monorail shifting device 1 is essentially the same. To engage a new gear, the selection actuator 13 first rotates the selector element 5 and the shifting element 3 until the shifting finger 4 is in the desired carrier groove 29 of the shifting fork arm 6, 7 or 8 to be selected. Thereby, the desired shifting gate is selected. Since the shift position detent 18 is arranged between the shifting element 3 and the selector element 5 and the shifting element 3 rotates together with the selector element, the force required for selecting the shifting gate remains relatively small and is completely uninfluenced by the shift position detent 18.

Once the desired shifting gate has been selected, the gearshift rail 2 is moved in the axial direction by the shift actuator (not shown). During this the gearshift rail 2 carries along the components in axially fixed connection with it, namely the shifting element 3 with the shifting finger 4, the shifting fork arm 6, 7 or 8 selected with the corresponding shifting fork 26, 27 or 28, and finally the associated shifting sleeve, to the desired shift position. During this shifting movement the retaining force of the shift position detent 18 is overcome. When the desired shift position has been reached, the shift position detent 18 engages again in a retaining recess provided for this.

To shift to another gear, the neutral position is first restored by the shift actuator and then the selection actuator selects the desired shifting gate, before the shift actuator then shifts to the desired target gear.

In the context of this invention shift position detents are also conceivable, which retain a neutral position and/or one or more shift positions. Clearly, the individual features of the embodiments described can be combined. For example, in the first embodiment the shifting element can also be of sleeve-shaped design and, conversely, in the second embodiment the shifting element can be made as a shifting ring.

### INDEXES

1 Monorail shifting device
2 Gearshift rail
3 Shifting element
4 Shifting finger
5 Selector element
6 Shifting fork arm
7 Shifting fork arm
8 Shifting fork arm
9 Locking element
10 Transmission housing
11 Central axis
12 Selection finger
13 Selection actuator
14 Extension
15 Recess
16 Retaining recess
16a Retaining recess
16b Retaining recess
17 Circlip
18 Shift position detent
19 Through-bore
20 Spiral compression spring
21 Detent element
22 Detent element
23 Spiral compression spring
24 Locking screw
25 Slot
26 Shifting fork
27 Shifting fork
28 Shifting fork
29 Carrier groove

1-10. (canceled)

11. A monorail shifting device (1) for a multi-gear variable-speed transmission with a gearshift rail (2), a shifting element (3) and a selector element (5),
the gearshift rail (2) being arranged and displaced in an axial direction in a transmission housing (10),
the shifting element (3) being fixedly connected to the gearshift rail (2) in the axial direction and transmitting an axial shifting movement selectively to one of at least two shifting fork arms (6, 7, 8),
the shifting element (3) being freely rotatable on the gearshift rail (2),
the selector element (5), in relation to the transmission housing (10), being fixedly arranged on the housing in the axial direction,
the shifting element (3) and the selector element (5) being pivotable together about a central axis (11),
the shifting element (3) being a shifting ring arranged on the gearshift rail (2) concentrically with the common central axis (11),
a shift position detent (18) being arranged to act between the shifting element (3) and the selector element (5),
at least one prestressed, springy detent element (20, 21, 22) being arranged on the shifting element (3) as part of the shift position detent (18), which is engagable in at least one retaining recess (16) in the selector element (5), and
the shift position detent (18) being arranged in a through-bore (19) in the shifting element (3) perpendicularly to the central axis (11) and comprising a spiral compression spring (20) at the two ends of which respective detent sleeves being arranged as the detent elements (21, 22), so that the detent sleeves (21, 22) are pushed in opposite directions into corresponding retaining recesses (16a, 16b) in the selector element (5).

12. The monorail shifting device (1) according to claim 11, wherein a locking element (9) is fixed solidly on the selector element (5) such that the shifting fork arms (6, 7, 8), which are not selected, are locked in a shift position in each case.

13. A multi-gear variable-speed transmission in combination with a monorail shifting device (1) for a multi-gear variable-speed transmission with a gearshift rail (2), a shifting element (3) and a selector element (5),
the gearshift rail (2) being arranged and displaced in an axial direction in a transmission housing (10),
the shifting element (3) being fixedly connected to the gearshift rail (2) in the axial direction and transmitting an axial shifting movement selectively to one of at least two shifting fork arms (6, 7, 8),
the shifting element (3) being freely rotatable on the gearshift rail (2),
the selector element (5), in relation to the transmission housing (10), being fixedly arranged on the housing in the axial direction,
the shifting element (3) and the selector element (5) being pivotable together about a central axis (11),
the shifting element (3) is a shifting ring arranged on the gearshift rail (2) concentrically with the common central axis (11),
a shift position detent (18) being arranged to act between the shifting element (3) and the selector element (5),
at least one prestressed, springy detent element (20, 21, 22) being arranged on the shifting element (3) as part of the shift position detent (18), which is engagable in at least one retaining recess (16) in the selector element (5), and
the shift position detent (18) being arranged in a through-bore (19) in the shifting element (3), perpendicularly to the central axis (11), and comprising a spiral compression spring (20) at the two ends of which respective detent sleeves being arranged as the detent elements (21, 22) so that the detent sleeves (21, 22) are pushed, in opposite directions, into corresponding retaining recesses (16a, 16b) in the selector element (5).

14. A monorail shifting device (1) for a multi-gear variable-speed transmission, the shifting device comprising:
a gearshift rail (2) being supported within a transmission housing (10) and defining a central axis (11), and the gearshift rail (2) being axially displacable;
a shifting element (3) being coupled to the gearshift rail (2) such that the shifting element (3) being axially fixed and freely rotatable with respect to the gearshift rail (2), and the shifting element (3) selectively transmitting axial shifting movement, in an axial direction, to one of at least two shifting fork arms (6, 7, 8), and the shifting element (3) being concentric with the gearshift element (2);
a selector element (5) being fixed, in the axial direction by and in relation to the transmission housing (10), the shifting element (3) and the selector element (5) being pivotable together about the central axis (11);
the shifting element (3) comprising a through-bore (19) extending perpendicularly with respect to the central axis;
a shift position detent (18) being located within the through-bore (19) and functionally coupling the shifting element (3) and the selector element (5);
the shift position detent (18) comprising a spring (20) and two detent sleeves (21, 22) which are supported by opposite ends of the spring (20), and the detent sleeves (21, 22) being biased by the spring (20), in opposite directions, into engagement with a respective retaining recess (16a, 16b) in the selector element (5) for engaging the selector element (5) with the shifting element (3).
